(19) United States
(12) Patent Application Publication
(10) Pub. No.: US 2003/0175526 A1
(43) Pub. Date: Sep. 18, 2003

(54) Shoe sole structure

(76) Inventor: Guang-Huo Lin, Taichung Hsien (TW)

Correspondence Address: Hart, Baxley, Daniels & Holton, Fifth Floor, 59 John Street, New York, NY, 10038, US

(21) Appl. No.: 10/095,170

(22) Filed: Mar. 12, 2002

(51) Int. Cl. C08J 9/00

(52) U.S. Cl. 428/423.3; 428/423.1

(57) ABSTRACT

A shoe sole structure includes at least two kinds of PU material and waste chips and a foaming agent are evenly mixed with the two kinds of PU material. The mixture is foamed and formed to be desired shapes.

### FIELD OF THE INVENTION

The present invention relates to a shoe sole structure that includes mixture of waste chips and PU and foaming agent.

### BACKGROUND OF THE INVENTION

A conventional shoe sole is made of PU which is mixed with foaming agent and the mixture is injected by a plastic injection machine. Generally, the PU material has only a single color so that it cannot be satisfied by the customers in the market. In some levels of the shoes market, the colorful shoes are welcomed by the customers so that how to make shoes having multiple colors without being suffered by high manufacturing cost is a main concern of the manufacturers.

The present invention intends to provide a shoe sole that includes PU and waste chips which are mixed with the PU so that the shoe sole has multiple colors and is made at a lower cost.

### SUMMARY OF THE INVENTION

In accordance with one aspect of the present invention, there is provided a shoe sole structure which is composed of at least two kinds of PU material and waste chips which is evenly mixed with the two kinds of PU material so that the shoe sole has multiple colors.

The primary object of the present invention is to provide a shoe sole that is composed of PU material and waste chips which has different colors from that of the PU.

Another object of the present invention is to provide a shoe sole structure that can be made at lower cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a shoe sole of the present invention;

FIG. 2 is a bottom view to show shoe sole of the present invention, and

FIG. 3 shows a mechanism for mixing the PU material and the waste chips.

### DETAILED DESCRIPTION OF THE PREFERRED EMBODIMENT

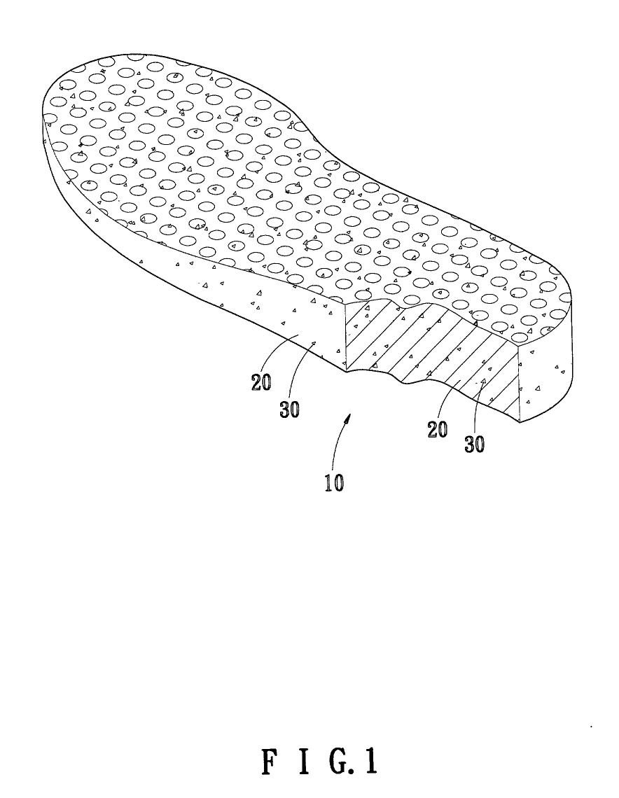

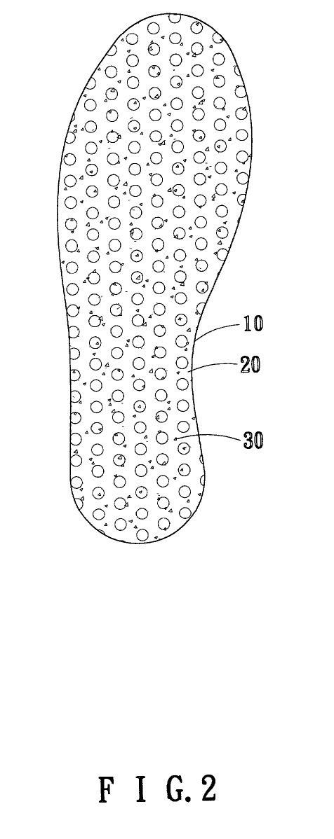

Referring to FIGS. 1 and 2, the shoe sole structure of the present invention comprises a body 10 made of at least two kinds of PU material 20 and waste chips 30. The waste chips 30 are evenly mixed with the two kinds of PU material 20 and a foaming agent so as to form a foamed mixture which is then put in a mold to form a shoe sole.

The colors of the waste chips 30 are different from the colors of the at least two kinds of PU material 20 so that the body 10 includes multiple colors.

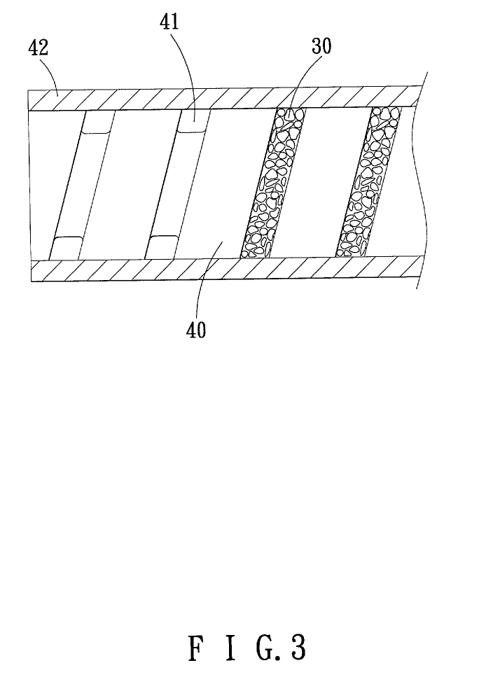

FIG. 3 shows that a mechanism 42 for mixing the PU material 20 and the waste chips 30 includes several feeding shafts 40. The feeding shafts 40 each have spiral grooves 41 and the waste chips 30 are fed into the PU material 20 evenly so that the waste chips 30 are securely evenly combined with the PU material 20. Using the waste chips 30 reduces the manufacturing cost of the shoe sole structure and the colors can be different and unique.

While we have shown and described the embodiment in accordance with the present invention, it should be clear to those skilled in the art that further embodiments may be made without departing from the scope of the present invention.

What is claimed is:

1. A shoe sole structure comprising:
a body made of at least two kinds of PU material and waste chips being evenly mixed with the two kinds of PU material.

2. The shoe sole structure as claimed in claim 1, wherein the at least two kinds of PU material and waste chips is evenly mixed with a foaming agent.

3. The shoe sole structure as claimed in claim 1, wherein colors of the waste chips are different from a color of the at least two kinds of PU material.
